(19) United States
(12) Patent Application Publication
(10) Pub. No.: US 2019/0232745 A1
(43) Pub. Date: Aug. 1, 2019

(54) HYBRID ELECTRIC VEHICLE

(71) Applicant: Dmitry Nikolaevich Kharitonov, Moscow (RU)

(72) Inventor: Dmitry Nikolaevich Kharitonov, Moscow (RU)

(21) Appl. No.: 16/311,415

(22) PCT Filed: May 30, 2017
(86) PCT No.: PCT/RU2017/000372

§ 371 Date: Dec. 19, 2018

(30) Foreign Application Priority Data
Jun. 22, 2016 (RU) 2016124867

(51) Int. Cl. B60F 5/02

(52) U.S. Cl. CPC B60F 5/02; B62K 21/00

(57) ABSTRACT

The hybrid electric vehicle belongs to the field of small aircraft. This vehicle is used to move people on the ground, like a regular motorcycle and to move people through the air like an autogyro. Hybrid electric vehicle can be used by citizens, organizations, government agencies to perform various tasks: personal and official transport, tourism, monitoring, patrolling, ambulance, etc.

The essence of the described vehicle is a change in the basic design of motorcycle, so that it has a mast and an autogyro rotor that can be removed, as well as the use of two ducted propellers with built-in electric motors, and an additional electric motor for the rotating of rear wheel. In this case, ducted propellers (together with the listed systems of parts, called elements of flight providing (EFP)) can be removed, as well as fixed in two positions. First, in such a way that their plane of rotation is perpendicular to the plane of rotation of the rear wheel (flight mode). And in this situation ducted propellers provide a opportunity where the total thrust vector generated by them is located much lower than in case of conventional autogyros and, accordingly, the vehicle's center of mass can also be located low—in the immediate vicinity of the thrust vector line, this opportunity will allow the vehicle to move steadily as in the air and on the ground. Secondly, in such a way that the ducted propellers (and the other parts of the EFP also) are pressed to the side parts of the hybrid avehicle, in a plane parallel to the plane of rotation of the rear wheel (ground mode) (see FIG. 1, FIG. 2, FIG. 3, FIG. 4, FIG. 5).

### FIELD OF TECHNOLOGY

The invention relates to the field of small aircraft. The invention can be used to create hybrid vehicles that can ride on ordinary roads like a motorcycle, and to fly like an autogyro (gyroplane). The headings of the international patent classification (IPC): B60 F 5/02—convertible aircraft.

### BACKGROUND

It is known that most motorcycles currently use a chain (or belt) drive for the transmitting torque from the transmission to the rear wheel.

It is also known that the torque is transmitted from the engine to the cruising propeller, either directly or via a reduction gear in autogyros. At the same time, firstly, in order to ensure sufficient thrust force for take-off, the autogyro propulsion screws must be of considerable diameters. Secondly, in order to avoid unstable behavior of the gyroplane in the air, the vector of thrust of the propulsion propeller must pass through the center of mass of the aircraft or slightly below the center of mass. To solve these problems, modern autogyros usually has small rear wheels on fairly high mounts, with the wheels spread over a distance sufficient to ensure the operation of one large main propeller.

The using of high rods with small wheels and, accordingly, a high center of gravity are the cause of very unstable behavior of gyroplane when moving on the ground. In addition, the position of the propeller behind the pilot reduces the flow of air to the propeller, and, consequently, leads to a loss of power. Such a fundamental technical solution (one big main propeller and small wheels on high rods) complicates the design and the using of hybrids autogyro-motorcycle, capable of confidently moving on the ground and in airspace.

Known attempts to create hybrid aircrafts capable for the moving on the ground, like a motorcycle, and in the air like an autogyro. The only similar feature of the invention and its analogs is that they all use the technologies, which has been used in the gyroplane for flight operations.

For example, US company Butterfly, LLC patented a flying motorcycle, called the Super Sky Cycle (information taken from web-site hftp://thebutterflyllc.com). This design contains standard for autogyros constructive solutions (large propeller behind the pilot, small rear wheels and at the same time a high center of gravity), which reduces the stability of the vehicle when riding on the ground.

As propeller in this design obscured by the pilot and the engine power losses appear. The Dutch company PAL-V is also developing the design of a flying motorcycle (infonnation taken from the site www.pal-v.com). In order to maintain the stability of the vehicle in the air, without disturbing its stability when moving on the ground, the Dutch designers used quite sophisticated technologies. First, it is a folding blades of rear propeller. Secondly, the technology allows, when moving on the ground, to make inclinations of the body of the vehicle in the direction of the radius of the turn circle. The solutions used by the PAL-V constructors to create a hybrid vehicle seems to be complicated, expensive, and incomplete. These solutions make it possible to ensure satisfactory stability of the vehicle when moving on the ground, however, costly, and the issue of power losses due to insufficient air flow to the cruising propeller is not resolved.

To create a hybrid vehicle, it is also necessary to unify control devices on the ground and in the air.

It is known that a V-shaped steering wheel is currently used to change the direction of the riding of motorcycle. The steering rack is attached directly to the fork of the front wheel, and also connected with a bearing (s) to the frame of the motorcycle. In this case, turning the steering wheel means turning the front wheel of the motorcycle in the desired direction and, accordingly, changing the direction of movement.

It is also known that to change the direction of movement of the autogyro, it is necessary not only to control the rotor, carried out by the rotor control knob by tilting it in the right direction, but also it is necessary to align the vehicle body in the direction of motion in order to avoid “sliding”. This alignment of the vehicle could be achieved by pressing on the foot pedals that drive the vertical rudder of the gyroplane. The lower part of the rotor control knob is usually connected to two steering racks. The tilts of rotor control knob back or forth causes the corresponding longitudinal movement of one steering rack relative to another. The tilts of the rotor control knob to the right and left causes the corresponding lateral movement of one steering rack relative to another. The steering racks are connected by hinges with vertical rods, which, in turn, are connected to the rotor hub. Thus, the tilt of the handle causes changes in the angles of the plane of rotation of the rotor and, accordingly, the direction of movement of the gyroplane.

In turn, in order to align the body position of the gyroplane relative to the direction of its movement, it is necessary to change the angle of the rudder. In modem autogyros, the change in the rudder angle occurs by pressing the right or left pedal, which are connected by cables with the rudder rails. if the pedals are not depressed, special springs return the rudder to the neutral position.

Increase or decrease in engine speed occurs by moving the engine control lever.

Thus, to control the autogyro, a pilot needs to use two hands (one hand changes the position of the control knob of the rotor, the other hand changes the position of the lever) and two legs (to control the rudder).

Motorcycle is often controlled entirely using the steering wheel and switches located on it (gas, clutch, brake).

Known attempts to create hybrid devices that can move on the ground, like a motorcycle, and in the air like an autogyro.

For example, the Super Sky Cycle contains design solutions that are standard for controlling the autogyro (in addition to the steering wheel of the motorcycle, there is a rotor control handle and pedals for steering to control the rudder), which makes it difficult to control the whole vehicle.

### SUMMARY

The task of creating of this invention was to design an vehicle that would optimally combine the possibility of sustained motion of the vehicle on the ground (when removing the rotor and conveniently placing it) and in the air with the least expenditure of time and money.

The result of the using of this invention will be the emergence of a mobile tunable vehicle that allows to convert the drive and control systems of the vehicle into the riding and flight modes. At the same time, the vehicle will not require airfield storage, but may be placed in a conventional garage or even in a parking lot.

To solve the task, it is necessary to make the following essential decisions:
to develop the folding flight power plant;
to develop hybrid systeme of control over the vehicle;
to develop the layout of a hybrid vehicle for the riding and for the flights.

Thus, the essence of the invention is the using of the power plant of a hybrid electric vehicle, devices for controlling a hybrid electric vehicle and the layout described below. A hybrid electric vehicle principally can be created by introducing changes to the powerplant of a motorcycle and adding elements of an autogyro such as a mast and rotor. However, the following layout conditions must be met at least, for the flight of a hybrid vehicle: thrust vector (1) must pass through the center of mass of the vehicle or below the center of mass, the moments of aravity of the front and rear parts (relative to the center of mass) of the vehicle must be equal, the rotor attachment point must be above the center of mass of the vehicle, or the center of mass must be under angle (7-10 degrees) between the vertical line passing through the point of suspension and the line connecting the point of suspension and the center of mass. The following changes should be made to the layout of the motorcycle (see FIG. 1). The engine (2), depending on its mass, should be located either under the center of mass or directly in the rear wheel (3).

In order for the vehicle to steadily ride, it is necessary to provide convenient folding of such flight accessories as the rotor (4) and the horizontal stabilizer. A special cavity is provided for the rotor (5). Thus, when folded, the rotor is located obliquely, one end of the rotor is located near the lower part of the front wheel (6) of the vehicle, the rotor line can pass near the fuel tank (7) and fuel cells (8) or with a electric battery (which can be used instead fuel tank systems plus fuel cells). Further, the rotor line passes over the rear wheel (3), and the other end of the rotor sticks out behind the motorcycle at a height sufficient for safe movement.

FIG. 2 shows the concept of the horizontal stabilizer design. The horizontal stabilizer of the vehicle consists of three parts: the central (1), right and left (2). The right and left parts of the horizontal stabilizer have flat protrusions on the ends, which are inserted into the slot of the central part of the stabilizer. The magnets could be at the ends of the projections (3), due to which the right side of the stabilizer is firmly pressed against the left side inside the horizontal part of the stabilizer. The connecting the left part of the stabilizer to the right part inside the central part can also be carried out in other ways, for example, by the using special brackets that can be installed in the upper part of the central stabilizer and pass through the central part of the stabilizer and the projections of the right and left part of the horizontal stabilizer. The stabilizer is experiencing only transverse loads, so these methods of fastening are sufficient. The removed left and right parts of the horizontal stabilizer can be mounted in special wire-frame pockets on the right and left side from the rear wheel.

The mast of the rotor of a hybrid vehicle could consists of the right and left units, and the rotor could pass between it, in the folding position in the riding mode.

To be able to use the power unit of the vehicle in both the riding mode and the flight mode, it is necessary to make the following changes to the basic design of the motorcycle. For the driving in riding mode, an electric motor could be in the rear wheel axle, and to receive electricity from fuel cells connected by a fuel tank or from the electric battery. Elements of flight providing (EFP) are used for flight and receive electricity from the same power source as the engine inside the wheel,

The elements of flight providing (EFP) are arranging on both sides of the rear wheel to the of the frame of the vehicle.

EFP consists of:
the sleeves of the stand of the balancing chassis, the sleeve could be fixed at one end with the help of a hinge to theboard, and another end on the surface of the ducted propeller;
the mount of the ducted propeller;
the electric motor rotating the propeller is located inside each ducted propeller on the axises of ducts;
ducted propeller, which is connected to the electric motor.

Modern ducts fabrication techniques (when the duct width is in a special relationship with the diameter of the propeller (usually one quarter) and the gap between the inner walls of the ducts and the edges of the blades is several millimeters) increases the thrust up to 30% compared with the conventional propellers of the same diameter and weight, but without the duct. The using of ducted propellers with small electric motors allows to obtain qualitatively different weights and sizes of vehicles. The rotation of the ducted propellers occur in opposite directions.

The diameter of both ducted propellers will be less than the diameter of a single conventional propeller, which would be required to ensure the flight of the aircraft of the same mass. This means that the center of gravity of the vehicle can be lowered by the amount of reducing the radius of the propeller. Consequently, the vehicle will be more stable than analogs when riding, while the stability in flights will also increase. When the vehicle rides without intent to make a flight, the EFP is folded, clinging to the sides of the vehicle. EFP can also be removed altogether. The rotor (when vehicle rides) is also removed from the mast and can be mounted under the seat of the vehicle. When vehicle rides (when the rotor of the autogyro is removed), the vehicle will be more stable than the closest analogues (PAL-V and Super Sky Cycle), since vehicle has a stable design of a regular motorcycle. The vehicle will be more stable during the flights, not only than PAL-V, Super Sky Cycle, but even than an ordinary gyroplane, due to the presence of two ducted propellers rotating in opposite directions (there are no reactive moments which rotate the vehicle around itself when pilot make a sharp reducing of speed or a sharp acceleration).

The following changes in the design of the motorcycle are necessary to be able to use the vehicle control system both in the motorcycle mode and in the autogyro mode.

The steering rack consists of two parts. The lower part of the steering rack has a cylindrical shape, the lower end of it is attached to the fork of the front wheel; and the other end is attached to CV joint that connects the lower steering rack and the upper steering rack. The hole for the fastening of the control switch sleeve with a pin is made on the surface of the lower steering rack, at its lower base. The lower steering rack is inserted into the tube of circular cross section, which is connected to the beam of the frame of the vehicle. The bearing that allows to make turns of the lower steering rack around its axisis is Inside the tube. The upper steering rack also has a cylindrical shape, however, a smaller section. The upper end of the upper steering rack is attached directly to the steering wheel. Two bearings are fixed on the axis of the upper steering rack, near the upper and lower ends, the size of the cross section of them is equal to the size of the cross section of the lower steering rack. Horizontal rails are attached to the outer edge of each of the bearings with horizontal joints. The other ends of the guide rails are connected by horizontal hinges with the rotor control knob. The upper steering rack has a hole, the stud can be inserted there, and the end of the control switch sleeve can rest on the stud for epy fixing the top position of the sleeve. The control switch sleeve is a cylindrical tube that can move up and down along the axles of the steering racks. At the same time, the sleeve of the control switch fits snugly enough to the surfaces of both bearings in the upper position. The sleeve of the control switch fits snugly to the surface of the lower steering rack in the lower position. In this case, the surface of the sleeve has a hole in the lower part, which can be aligned with the hole in the lower steering rack and the sleeve can be fixed in this position with a pin. The control switch sleeve has a vertical slot for the guide rails connecting the outer sides of the bearings and the rotor control knob through horizontal hinges can pass through this slot. The rotor control knob has the fastening, standard for autogyros with rotor control strips. Thus, when the control switch sleeve is in the upper position, the tilt of the steering wheel in either direction leads to the corresponding tilt of the rotor control knob. The guides for the rudders are attached at the bottom of the lower steering rack and looks like two small pins. The rudder wires are attached to the ends of the guides. The control pins are attached to the steering axis, where two sprocket-wheels are fixed to control the left and right rudders. A rudder shaft rotating on bearings is inserted into the propeller ducts, and semicircular ducts covers are attached to the shaft. One of the covers is rigidly attached to the rudder shaft, the other cover can freely rotate on the shaft and fasten with the other cover, while the surfaces of the covers are touching. An sprocket-wheel of the directional shaft is installed on the upper part of the rudder shaft Each of the sprocket-wheels located on the control axis is connected by a chain with the sprocket-wheel of the corresponding rudder shaft. Thus, turning the steering wheel of the vehicle causes horizontal movements of the guides; these movements are transmitted by means of tail cables to the axis control pins, causing it to rotate. The rotation of the axis occurs simultaneously with the rotation of the sprocket-wheel located on it. Rotation from the sprocket-wheel located on the axis is transmitted by means of chains to the sprocket-wheels of the left and right shafts of the rudders and, respectively, to the shafts of the rudders. Rotation of the rudder shafts causes the turns of the left and right rudders (representing folded and fastened covers of the ducted propellers). Thus, turning the steering wheel around the axis will cause the front wheel to turn and change the direction of the rudders. Control of the vehicle on the ground (when the control switch sleeve is fixed in the lower position) is reduced to steering turns around the axis. In this position, the control switch sleeve does not allow tilting the steering wheel. Control of the vehicle in the air, either in the “take off” or “landing” modes (when the control switch sleeve is fixed in the upper positions is reduced to steering turns around the axis and steering tilts in any direction. In this position, the sleeve control switch allows not only to make the steering turns around the axis, but also its tilts in any direction. The throttle with this control can be replaced, and to use the same as on motorcycles, with a gas adjustment knob.

The calculations show approximate relations of the flight mass, thrust and engine power (See table 1, information from www.prostor.webzone.ru)

| Power (hp) | Static thrust (kg) | Weight of gyroplane (kg) |
|---|---|---|
| 22 | 70 | 140 |
| 35 | 110 | 220 |
| 45 | 140 | 280 |
| 64 | 160 | 320 |
| 80 | 200 | 400 |

It is known that light models of motorcycles (for motocross, off-road motorcycles, including electric ones) with an engine power up to 50 hp (enough for a flight of gyroplane with a flight weight up to 300 kg) weighs about 90 kg. To calculate the mass of a single-seater hybrid vehicle, it is necessary to add the rotor mass (about 17 kg), the mass of two ducted propellers with balancing chassis (about 10 kg) to the specified mass of the motorcycle, the weight of the rear wheel, if carbon fiber is used, remains almost unchanged, the mass of the horizontal stabilizer (about 5 kg) and the mass of the mast of the rotor (about 7 kg), the mass of the flexible drive for the pre-rotation of the rotor (2 kg). As a result, the mass of a single hybrid vehicle (motorcycle-gyroplane) without a pilot could be about 133 kg (depends of electric battery).

For the purposes of calculations, it is necessary to be guided by the following ratio of thrust and diameters of ducted propellers (according the information provided by Trek Aero—the developer of ducted propellers, see table 2):

| | Single seat vehicle | | | Double seat vehicle | |
|---|---|---|---|---|---|
| Static thrust, kg | 133 | 132 | 132 | 253 | 259 |
| Inner diameter of | 550 | 600 | 750 | 750 | |
| duct, mm | | | | | |
| Outside diameter | 634 | 692 | 865 | 865 | |
| of duct, mm | | | | | |
| Chord of duct, MM | 153 | 167 | 208 | 208 | |
| Quantity of blades | 4 | 3 | 2 | 4 | |
| of propeller | | | | | |
| Propeller speed, rpm | 7200 | 6600 | 5300 | 5300 | |
| Power of motor, hp | 50 | 44 | 36 | 92 | 95 |
| Weight of duct, kg | 1.45 | 1.75 | 2.70 | 2.70 | 2.70 |
| Weight of propeller, | 3.41 | 2.95 | 2.50 | 4.15 | 4.25 |
| kg | | | | | |

It is possible to determine approximately the power of the engine from these tables, which is required for single-seat and double-seat vehicles. For example, you will need 2 electric motors with 18 horsepower of motor if vehicle weight is 130 kg, to take off the vehicle (with a pilot). Such electric motors are available for the purchasing and their weight is about 2-3 kg.

The technical result of the application would be the developed layout, power system for the hybrid electric vehicle which can steadily move both on the ground and in the air, will be easier and reliable than its closest counterparts.

### BRIEF DESCRIPTION OF THE FIGURES

There are three figures in the description, reflecting the essential features of the invention.

FIG. 1 is a schematic layout of the hybrid vehicle.

FIG. 2 shows the mechanism of a horizontal stabilizer of a hybrid vehicle.

FIG. 3 shows a schematic of EFP of a hybrid vehicle.

FIG. 4 shows the system of the controlling of hybrid vehicle.

FIG. 5 shows the controlling of rudder directions.

For convenience of illustration, the figure shows non-ducted propellers.

### DESCRIPTION

The invention can be materialized by applying the hybrid vehicle layout described above as well as the using of EFP.

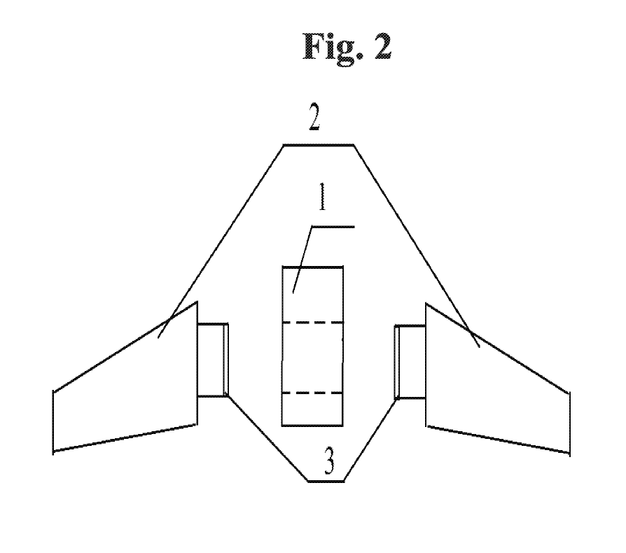

The power plant of a hybrid (convertible) vehicle can be materialized as follows. The power plant device contains (see FIG. 2 in the figure, the ducts around the propellers are not shown):

(1) Metal (or metal, carbon-reinforced) side parts of the vehicle frame. They are located on both sides from the rear wheel. Systems of parts, called in this description as elements of flight providing (EFP) are fastened to frame of vehicle by means of a hinged fastener (which can be rigidly fixed).

(2) Rear wheel with electric motor on the rear wheel axle is attached to the fork.

(3) Top mount EFP. Allows a rigid fixation of the EFP to the frame of vehicle.

(4) Ducted propellers made from composite materials are on the axis of electric motors and ducts. The diameter of the duct is selected depending on the weight of the vehicle and, accordingly, the required thrust.

(5) Metal rack of balancing chassis. It has a cylindrical shape. Attached to it balancing chassis. The rack can be retracted into the sleeve and rigidly fixed both in the retracted and unfolded state with the help of holes in the rack as well as in the sleeve and small steel pins or screws and nuts.

(6) Metal sleeve for the rack of balancing chassis. It could have the shape of a hollow cylinder with holes for mounting the balancer rack. The rack of balancing chassis can be positioned inside the sleeve when the balancing chassis is removed for the using of the vehicle for the riding. The upper end of the sleeve is attached to the top EFP mount.

(7) Balancing chassis. They are used for balancing the vehicle in the “takeoff”, “landing” modes. They also prevents the ducted propellers from hit the ground. They do not perceive the load of the vehicle, but serve for the balancing of the vehicle in the modes mentioned above.

(8) Metal sliding mount. It can be a tube of round or rectangular cross section (depending on the cross section of the part of frame of the vehicle contacting with the mount). The tube is dressed on the part of frame of the vehicle and can move along it and be fixed in two positions on the part of the frame (in the position when the EFP is folded along the side of the vehicle for the riding mode and in the position when the ducted propellers are installed in a plane perpendicular to the plane of the rear wheel—the flight mode). Fixation can be done by installing a small pin in the holes on the sliding mount and the frame of the vehicle. Sliding can also be implemented in another way, for example, in the form of a simple cylinder moving in the slot of the frame or another horizontal part of the motorcycle.

(9) The metal bar can have any profile, but strong enough. it serves to fix the EFP in two positions: in flight position, when the ducted propellers are located in a plane perpendicular to the plane of the rear wheel and in the ground position, when EFP and ducted propellers are arranged along the body of the vehicle. The frame bar is connected at one end with a sliding mount, the other end is connected with a hinged mount on the sleeve.

(10) A metal hinge mount on the metal sleeve connects the metal bar and the metal sleeve.

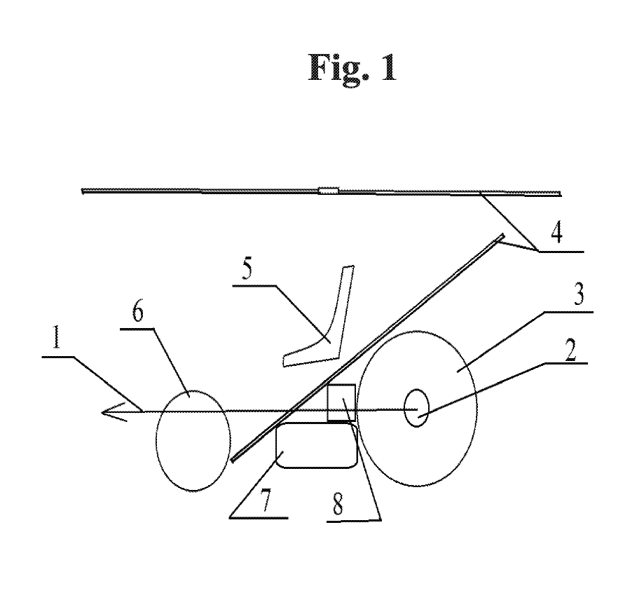

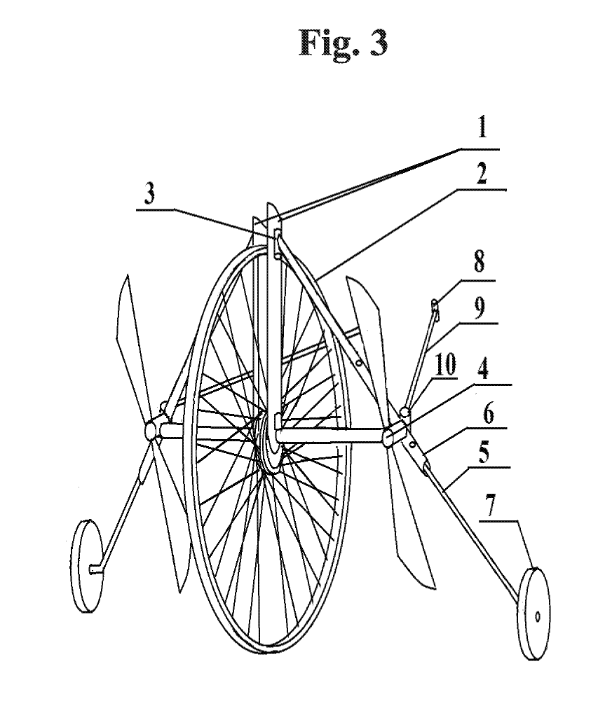

When the using of the vehicle in the ground mode is necessary, the electric current from the fuel elements (8) is supplied to the engine (2) located on the rear wheel axis, causing the rear wheel (3) to rotate and the vehicle to move forward, respectively (see FIG. 1). At this time, the sliding mount (8) is moved along the horizontal part of frame of the vehicle and installed in the most extreme position (as close to the front wheel as possible) and fixed in this position (see FIG. 3). in this case, the EFP and the ducted propellers took up position along the sides of the vehicle. The racks of the balancing chassis (5) are put into the sleeves (6) and fixed. The power plant of the vehicle is ready for the riding. The rear wheel (2) ensures a steady movement of the vehicle in the riding mode when the center of mass has been lowered significally (the lowering is achieved by the reducing of diameter of ducted propellers)

When it is necessary to use the vehicle n the gyroplane mode, the current enters to the electric motors located in the centers of the ducted propellers (4), causing the propellers to rotate. Sliding mount (8) is moved along the horizontal part of frame of the vehicle and installed in the most extreme position (as close to the rear wheel as possible) and fixed in this position. In this case, the EFP and the ducted propellers took up the position perpendicular to the rear wheel. Rack of balancing chassis (5) extended from the sleeves (6) and fixed. The power plant of vehicle is ready for flight. Since the propellers (4) rotate in opposite directions, this makes it possible to compensate the reactive moments connected with a sharp increase; decrease in engine speed. It means that the vehicle in these situations does not turn in the air in the directions transverse to the forward movement. The low location of the thrust vectors of the ducted propellers (due to the reduced diameter of each of the two ducted propellers, as compared with the situation when only one large propeller is in vehicle) are used to ensure the longitudinal stability of the vehicle when during the flights (the vehicle will not swing up and down relative to its center of mass).

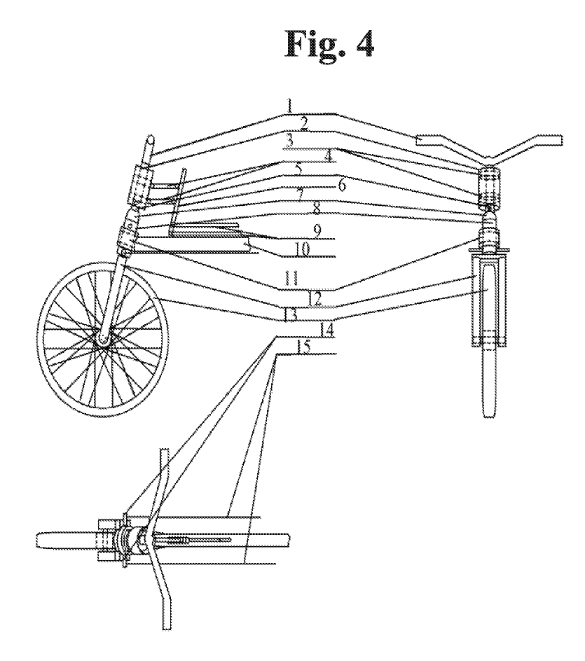

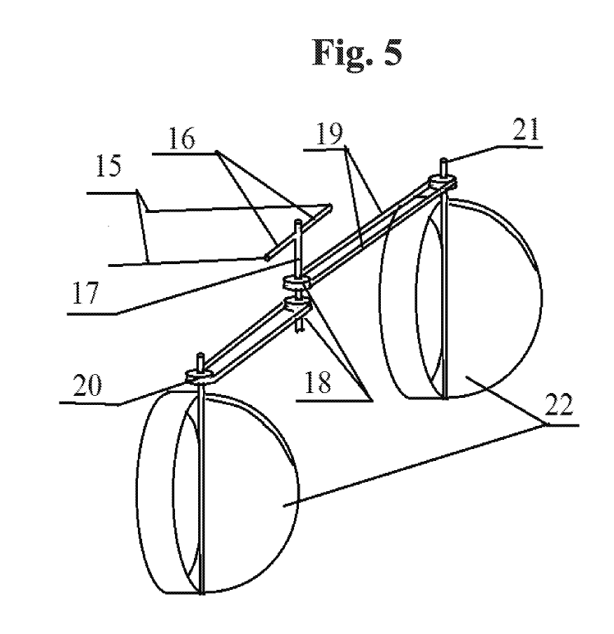

The control device of the hybrid electric vehicle can be materialized as follows. The device contains (see FIGS. 4 and 5):

(1) Metal V-shaped steering wheel, which is attached to the upper end of the upper control rack.

(2) The metal sleeve of the control switch has the shape of a cylindrical tube. A hole is drilled in the tube to fix the tube with a pin to the lower control rack. There is a vertical slot in the tube through which the horizontal hinges of the guide rails must pass.

(3) The metal bearings of the control switch are fixed to the axis of the upper control rack. The diameter of the bearings is slightly smaller than the inside diameter of the sleeve of the control switch and the sleeve of the control switch can move along the axis of the upper control rack. The guide rails are attached to the outer surface of the bearings using horizontal hinges.

(4) The metal guide rails are in the form of thin, elongated cylinders. They are attached by one ends with the help of horizontal hinges to the outer sides of bearings mounted on the axis of the upper steering rack, and with the other ends by means of horizontal hinges to the rotor control knob.

(5) The metal upper steering rack has a cylindrical shape. The steering wheel is attached to the upper end of this rack, the lower end is connected to the CV joint. Two control switch bearings are located on the axis of the upper steering rack. The upper steering rack has a hole above the junction with the CV joint to install the stud (the stud is not in the diagram) the top position of the control switch sleeve.

(6) The metal rotor control knob has a cylindrical shape, attached by its lower part to the rotor control rails. Rails are attached to the side of the rotor control knob by means of horizontal hinges.

(7) The CV joint of the lower steering rack connects the upper and lower steering racks, which are attached to it with the ends. The diameter of the CV joint is slightly smaller than the inside diameter of the control switch sleeve.

(8) The metal lower steering rack has a cylindrical shape. Its lower end is connected to the front wheel fork, and rudder guides are attached on the side surfaces at the lower end. The diameter of the lower steering rack slightly less than the internal diameter of the sleeve control switch and when the sleeve moves on the steering rack, it is quite tight to her. The upper end of the lower steering rack connected to the CV joint.

(9) The metal rotor control rails have a cylindrical shape, connected by hinges with the rotor control knob. At the same time, the lower rail is connected by a hinge to the frame part. Thus, the control rails can move relative to each other in longitudinal and transverse planes.

(10) The metal frame part has a cylindrical shape, is part of the frame design of the vehicle. A steel tube with a mounted steering bearing is attached to its front end.

(11) The metal steering bearing is mounted in a steel tube that ends the frame part. The bearing is attached to lower steering rack, which can freely rotate around its axis.

(12) The metal fork of the front wheel is connected to the end of the lower steering rack, which transmits rotation to it. The lower parts of the fork connected to the axis of the front wheel, which passes through the front wheel bearing.

(13) The front wheel of the vehicle can be performed as a light wheel of a motorcycle or moped. In the case when, the front wheel also acts as a rudder in the air, wheel rim is connected to the bearing using a solid (or semi-solid) plate of lightweight material instead of the spokes.

(14) The rudder guides are steel pins, with one of their ends attached to the sides of the lower steering rack.The steel pins are fixed with the rudder cables at the opposite ends.

(15) Rudder cables are attached at one end to the ends of rudder fins, and other ends are connected to rudder guides (not shown in the diagram).

(16) The metal pins of the axle control are mounted on the axle, connected to the rudder fin guides with rudder cables.

(17) The metal axis is a shaft of thin section, where the axis control pins, right-hand sprocket-wheel sprocket and left-hand sprocket-wheel fixed.

(18) The metal sprocket-wheels of the right and left rudders are fixed on the axis, the chains connect them, respectively, with the left and right sprocket-wheels of the shafts of the rudders.

(19) Metallic chains of sprocket-wheels connect the corresponding sprocket-wheels of the axis and the sprocket-wheels of the shafts of the rudders.

(20) Metal sprocket-wheels of the left and right shafts of the rudders are fixed respectively on the axes of the left and right shafts of the rudders, connected with chains, respectively, with the sprocket-wheels on the axis so that the rotation of the axis causes the rotation of the sprocket-wheel of the rudder shaft .

(21) Metal left and right rudder shafts penetrate vertically along the diameter of the rear parts of the rings of the looped-up propellers and are fixed in the rings with bearings, or they can be mounted with the help of bearings on the hinges attached to the rear parts of the rings of the looped-like propellers.The sprocket-wheels of the shafts of the rudders are mounted on the axis of the shafts of the rudders, over the ducts of the ducted propellers. Ducted propeller covers are attached to the outer surface of the rudder shafts so that one of the covers can freely rotate on the shaft and the other is rigidly connected to it.

(22) Ducted propeller covers are made of composite materials. They geometrically represent the halves of a circle. Ducted propeller covers are attached by the straight sides to the shafts of the rudders. One of the covers is rigidly attached, another can freely rotate around the shaft. The covers can be connected together using magnets located on rounded surfaces, or using other fasteners. The covers of each of the ducted propellers joined together are right or left rudders.

When it is necessary to use the vehicle in ground mode, the control switch sleeve (2) is set to the lower position—it embraces the lower steering rack (8). The lower bearing of the control switch (3) is pressed against the inner top of the sleeve of the control switch (2), the other end of the sleeve is attached through the hole to the lower steering rack (8). Now the torque from the steering wheel (1) is transmitted through the upper steering rack (5) , CV Joint (7), lower steering rack (8), front wheel fork (12) on the front wheel (13), causing it to turn in the necessary direction. When the control switch sleeve (2) is in the lower position, it does not allow tilting of the steering wheel (1), as it tightly covers the lower bearing of the control switch (3) and the lower steering rack (8). As soon as the control switch sleeve (2) is moved to the upper position and installed over the stud placed in the lower edge of the upper steering rack (5), the steering tilt (1) becomes possible, because the control switch sleeve (2) does not simultaneously fix the bearing position control switch (3) and lower steering rack (8), and covers only two bearings. The steering slopes (1) are transmitted through the guide rails (4) to the rotor control handle (6), and through it to the rotor control rods (9). At the same time, steering wheel turns (1) around the axis are also possible, which, firstly, carry out the front wheel turns (13), which can act as a rudder, and secondly, the steering wheel turns (1)cause the tail feathers to move (14), which by means of rudder guides (15) cause the movements of the axle control pins (16) and, accordingly, the rotation of the axis (17). The rotation of the axis (17) is transmitted to the sprocket-wheels of the right and left rudders of the direction (18) located on it, and from them the rotation is transmitted via the chain (19) to the sprocket-wheels of the left and right shafts of the rudders of the direction (20) and, respectively, to the shafts of the rudders (21), which are folded covers of the ducted propellers (22).

Thus, the invention “Hybrid electric vehicle” allows you to create the vehicle that can move on the ground like a normal motorcycle, allows storage in ordinary garages and parking lots, if necessary, can take off and fly over considerable distances.

What is claimed:

1. A hybrid electric vehicle designed for the riding on ground as a two-wheeled motorcycle, and for the flight in the air as an autogyro with a mast, rotor, characterized by the fact that it includes folding and fixed in planes perpendicular to the rear wheel two ducted propellers with electric motors on the axes of propellers, however, ducted propellers provide a situation where the total thrust vector generated by them is located much lower than in case of conventional autogyros and, accordingly, the vehicle's center of mass can also be located low—in the immediate vicinity of the thrust vector line, this opportunity will allow the vehicle to move steadily as in the air and on the ground and an electric motor that drives (sets in motion) the rear wheel.

2. Hybrid electric vehicle according to claim 1, characterized in that the electric motor that drives the rear wheel is built into the rear wheel.

3. Hybrid electric vehicle according to claim 1, characterized in that the electricity in it is produced by fuel cells.

4. Hybrid electric vehicle according to claim 1, characterized in that it has a control device that includes an upper steering rack with two bearings on its axis and a lower steering rack with two guide pins, both racks are connected by a CV joint, the switch sleeve can move between them and be installed in a position when it covers only the bearings of the upper steering rack, allowing you to tilt the steering wheel and turn it around its axis, or when the switch sleeve covers it also provides a CV joint and lower steering rack, allowing only steering to be performed around its axis, while the control switch sleeve has a vertical slot through which the guide rails pass, with one end connected by horizontal hinges to the outer sides of the upper steering rack bearings, and other ends are connected by horizontal hinges to the rotor control knob, so that the tilts of the steering wheel tilt the rotor control knobs, and the steering wheel turns are transmitted using guide pins, cables, chains and sprocket-wheels of rudders shaft to the rudders, which is a two semicircular folding and fastening covers of ducted propellers.

5. A hybrid electric vehicle according to claim 1, characterized in that it provides an opportunity for movement in ground mode to thrust the rotor under the seat in such a way that one end of the rotor is located near the bottom of the front wheel and the other end of the rotor passes over the rear wheel and sticks out behind, at a height sufficient for safe movement.
